(19) United States
(12) Patent Application Publication
(10) Pub. No.: US 2026/0141231 A1
(43) Pub. Date: May 21, 2026

(54) TRAINING METHOD AND DEVICE FOR ANALOG HARDWARE NEURAL NETWORK

(71) Applicant: NANJING UNIVERSITY, Jiangsu (CN)

(72) Inventors: Feng MIAO, Jiangsu (CN); Cong Wang, Jiangsu (CN); Shijun Liang, Jiangsu (CN); Yichen Zhao, Jiangsu (CN)

(73) Assignee: NANJING UNIVERSITY, Jiangsu (CN)

(21) Appl. No.: 19/181,250

(22) Filed: Apr. 16, 2025

Related U.S. Application Data
(63) Continuation of application No. PCT/CN2024/132230, filed on Nov. 15, 2024.

(30) Foreign Application Priority Data
May 24, 2024 (CN) 202410650458.5

(51) Int. Cl. G06N 3/065

(52) U.S. Cl. CPC G06N 3/065

(57) ABSTRACT

Disclosed are a training method and device for an analog hardware neural network, the method includes: inputting analog signals into the analog hardware neural network, and measuring output results of the analog hardware neural network after the analog hardware neural network establishes a response to the inputted signals; injecting a perturbation signal into a node while the analog hardware neural network is running; and updating parameters of the analog hardware neural network according to results of two measurements. The present disclosure has a higher recognition rate and generalization capabilities, and is applicable to training all types of analog hardware neural network, thereby solving the problem of reliance on a mathematical model in training of the analog hardware neural network.

### CROSS-REFERENCE TO RELATED APPLICATION

This application is a continuation of international application of PCT application serial no. PCT/CN2024/132230 filed on Nov. 15, 2024, which claims the priority benefit of China application no. 202410650458.5 filed on May 24, 2024. The entirety of each of the above-mentioned patent applications is hereby incorporated by reference herein and made a part of this specification.

### TECHNICAL FIELD

The present disclosure relates to a neural network algorithm, and particularly relates to a training method and device for an analog hardware neural network.

### BACKGROUND

Compared with the current research hotspots in digital neural networks (such as CNN, ANN, and GNN), analog hardware neural networks have lower power consumption and simpler circuit structure. Since a computational process of analog hardware neural network neither involves analog-to-digital/digital-to-analog (AD/DA) conversion nor requires binary encoding in computers, the circuit design for the entire computational process is more streamlined. In addition, since the circuit is more streamlined and intrinsic properties of the system are used for computation, the entire system has extremely high energy efficiency, making it very suitable for the deployment of artificial intelligence (AI). In an all-optical neural network based on principles of optics, weight information of the neural network is stored in a diffraction grating. When passing through the grating, light is diffracted after being modulated by the grating, thereby performing computations and projecting the diffracted light onto a detection screen. A process of optical computation is essentially a process of light propagation in space, and a computational speed of the all-optical neural network is only limited by a speed of light, therefore, the all-optical neural network can quickly complete computations that would spend lots of time in conventional digital neural networks. In a fully analog memristor-based neural network based on memristors, weight information of the neural network is a conductance value of the memristors, and a plurality of memristor arrays and nonlinear computational units are cascaded to form a multilayer analog hardware neural network. When a sensor or a signal source inputs an electrical signal to a front-end memristor, the electrical signal propagates through the array at a speed close to the speed of light and is modulated by the conductance, facilitating a large amount of neural network computations at high speed and in parallel.

A backpropagation (BP) algorithm is a method for training digital neural networks. Basic idea of the BP algorithm is to calculate an error between predicted results and actual results, to propagate the error back to each node of the neural network, and to adjust weights and bias parameters in the neural network according to the error, such that the predicted results of the neural network gradually approach the actual results. However, when the BP algorithm is applied to the training analog hardware neural networks, some serious error problems will occur. Common practice of training an analog hardware neural network is to model the analog hardware neural network first to obtain a mathematical model, then to use the BP algorithm to train in software according to the mathematical model, and finally to update the trained weights, biases and other parameters in an analog hardware neural network system. Unlike conventional digital computers, the analog hardware neural network system cannot precisely execute a computational instruction. A computational process of the analog hardware neural network system relies on state evolution in the analog hardware neural network system. Therefore, in order to perform error transmission of backpropagation, the mathematical model must be used for computation. However, the method of training the analog hardware neural network system by relying on the mathematical model causes many problems, particularly when training an analog hardware neural network system based on analog signals, the method have apparent limitations and drawbacks. Training a mathematical model of the analog hardware neural network using the BP algorithm may result in training failure or produce a neural network with an unacceptable recognition rate.

A new solution is to adopt a hybrid computing architecture. For the hybrid computing architecture, a forward propagation process is executed in the analog hardware neural network system, while a backpropagation process needs to use chain rule in mathematics, is still computed based on a mathematical model. Training of the hybrid computing architecture leverages both the mathematical model and the analog hardware neural network system itself, but does not completely relies on the mathematical model for pre-training. However, in the hybrid architecture, since the backpropagation process still relies on the chain rule in the model to compute gradients at each layer, the gradients obtained through the backpropagation will inevitably differ from actual gradients, which in turn lead to deviations in parameter updates of the neural network. The deviations will severely weaken the performance of the neural network, making the neural network unable to achieve a higher recognition accuracy (limited by a model error) and even causing failure of the neural network. In addition, as the analog hardware neural network system is increasingly complex, the difficulty of modeling the analog hardware neural network system increases exponentially. It is even impossible to establish a mathematical model for some complex systems, which means that it is difficult for the people to train highly complex analog hardware neural networks, significantly limiting the development of analog hardware neural networks.

### SUMMARY

An objective of the present disclosure: in view of the above problems, the present disclosure provides a training method and device for an analog hardware neural network, which have a higher recognition rate and generalization capabilities than the prior art, and are applicable to training all types of analog hardware neural network, thereby solving the problem of reliance on a mathematical model in training of the analog hardware neural network.

Technical solution: a technical solution adopted by the present disclosure is a training method for an analog hardware neural network, including the following steps: converting training data into analog signals, inputting the analog signals into the analog hardware neural network, and recording labels of the training data; acquiring internal signals of the analog hardware neural network after the analog hardware neural network establishes a response to the input signals, converting the internal signals into digital signals, and calculating a loss value of the analog hardware neural network; injecting a perturbation signal z into a node a of a nonlinear unit in the analog hardware neural network, and calculating a gradient of the loss value of the neural network relative to the node a according to changes in the loss value of the neural network before and after the perturbation signal is injected; traversing nodes, calculating physical parameter matrix adjustment values of elements in an analog computing-in-memory array of each layer of the neural network according to a gradient of the loss value of the analog hardware neural network relative to each nonlinear unit layer and the acquired internal signals of the analog hardware neural network, as well as a connection relationship between each nonlinear unit layer and the elements in the analog computing-in-memory array; and adjusting physical parameters of the analog computing-in-memory array of each layer of the neural network according to the physical parameter matrix adjustment values of elements in an analog computing-in-memory array of each layer of the neural network to realize the training of the analog hardware neural network.

The acquiring internal signals of the analog hardware neural network, converting the internal signals into digital signals, and calculating a loss value of each layer of the analog hardware neural network includes: acquiring analog input signals of the computing-in-memory array of each layer of the neural network and analog output signals of the analog hardware neural network, converting the analog input signals and the analog output signals into digital signals, and calculating a loss value (Loss) of the neural network according to the converted analog input signals and the analog output signals.

The loss value Loss of the neural network is calculated according to the converted analog input signals and analog output signals using a mean-squared error function as follows:

$$Loss = \frac{1}{n} \sum {( y - label )}^{2}$$

in the formula, y is an analog output signal of the analog hardware neural network after being converted by an analog-to-digital converter (ADC), label is a label of the corresponding training data, and n is a number of samples of the training data.

For the calculating a gradient of the loss value of the neural network relative to the node a according to changes in the loss value of the neural network before and after the perturbation signal is injected, a calculation formula is as follows:

$$∇ Loss {\vert}_{a} = \frac{\partial Loss}{\partial z}$$

in the formula, ∇Loss|ₐ is a gradient of the loss value of the neural network relative to the node a, an amplitude Δz of the perturbation signal z is used to replace ∂z for calculation, and changes in the loss value of each layer of the neural network before and after the perturbation signal is injected are used to replace ∂Loss for calculation.

The gradient of the loss value of the analog hardware neural network relative to each nonlinear unit layer is composed of gradients of the loss value of the neural network relative to nodes of each nonlinear unit, which can be expressed as a vector, and a calculation formula is as follows:

$$δ {\vert}_{n} = [ ∇ Loss {\vert}_{a 1} , ∇ Loss {\vert}_{a 2} , … , ∇ Loss {\vert}_{a m} ]$$

in the formula, δ is a gradient of the loss value of the neural network relative to a nonlinear unit layer, a subscript n represents an n^{th} nonlinear unit layer, subscripts a1, a2, am, and the like, represents gradients of the loss value of the neural network relative to different nodes, and m is a total number of nonlinear unit nodes in an n^{th} layer.

For the traversing nodes, calculating physical parameter matrix adjustment values of elements in an analog computing-in-memory array of each layer of the neural network according to a gradient of the loss value of the analog hardware neural network relative to each nonlinear unit layer and the acquired internal signals of the analog hardware neural network, as well as a connection relationship between each nonlinear unit layer and the elements in the analog computing-in-memory array, a calculation formula is as follows:

$$Δ W = η ( {I}_{n} \times δ {\vert}_{n} ) .$$

in the formula, W represents a physical parameter matrix of elements in an analog computing-in-memory array in an n^{th} layer, η is an adjustment coefficient of the physical parameter matrix, δ|ₙ is a gradient of the loss value of the neural network relative to an n^{th} nonlinear unit layer, and Iₙ is an input signal of the analog computing-in-memory array.

The present disclosure further provides a training device for an analog hardware neural network, including a digital-to-analog conversion (DAC) module configured to convert training data into analog signals, and input the analog signals into the analog hardware neural network;
a perturbation signal generation and injection module configured to inject a perturbation signal into a node of a nonlinear unit in the analog hardware neural network;
a perturbation signal detection and readout module configured to acquire internal signals of the analog hardware neural network, convert the internal signals into digital signals, and send the digital signals to the system control module; and
a system control module configured to calculate a loss value of the neural network according to the converted internal signals of the analog hardware neural network, calculate a gradient of a loss value of the neural network relative to the node a according to changes in the loss value of the neural network before and after the perturbation signal is injected; traverse nodes, and calculate physical parameter matrix adjustment values of elements in an analog computing-in-memory array of each layer of the neural network according to a gradient of the loss value of the analog hardware neural network relative to each nonlinear unit layer and the acquired internal signals of the analog hardware neural network, as well as a connection relationship between each nonlinear unit layer and the elements in the analog computing-in-memory array; and adjust physical parameters of the analog computing-in-memory array of each layer of the neural network according to the physical parameter matrix adjustment values of elements in an analog computing-in-memory array of each layer of the neural network.

The acquiring internal signals of the analog hardware neural network includes: acquiring analog input signals of the computing-in-memory array of each layer of the neural network and analog output signals of the analog hardware neural network.

The analog computing-in-memory array includes a memristor array, a current mirror array, and a floating gate transistor array; where for the memristor array, the adjust physical parameters of the analog computing-in-memory array of each layer of the neural network involves using a pulse signal to modulate conductance values of memristors; for the current mirror array, the adjust physical parameters of the analog computing-in-memory array of each layer of the neural network involves using a pulse signal to update values in a switch register, thereby changing switch states of transistors in a current mirror; and for the floating gate transistor array, the adjust physical parameters of the analog computing-in-memory array of each layer of the neural network involves adjusting gate voltages applied to transistors.

Amplitude and frequency of a perturbation signal generated by the perturbation signal generation and injection module are adjustable.

The perturbation signal generation and injection module includes a voltage source/current source, an adjustable resistor, and a multiplexer; where the voltage source/current source generates a reference bias signal, and generates a perturbation signal with adjustable amplitude by using changes in a resistance value of the adjustable resistor; and the multiplexer is configured to selectively connect nodes and inject perturbation signals into the nodes.

Beneficial effects: compared with the prior art, the present disclosure has the following advantages: the present disclosure adopts a perturbation propagation method to calculate the gradient value during the forward propagation process, and the physical parameters of the analog computing-in-memory array in the analog hardware neural network are adjusted based on the gradient of each node, thereby achieving the purpose of training the analog hardware neural network. Therefore, the present disclosure does not need to model the analog hardware neural network system to obtain a mathematical model, but can be directly used to training the analog hardware neural networks in any state. Without relying on a mathematical model, the present disclosure eliminates the training deviation caused by mismatches between the mathematical model and the actual system, thereby further improving the recognition rate and training performance of the analog hardware neural network. Compared with traditional BP algorithm or hybrid computing architecture, the method of the present disclosure is more suitable for a dynamically changing real-world analog hardware neural network system, and can adapt to different states of the analog hardware neural network system, so as to train the analog hardware neural network with high performance. In addition, since backpropagation is not used for computation any longer, the present disclosure greatly reduces memory usage and computational energy consumption, such that the low-power consumption of the analog hardware neural network is fully leveraged.

### BRIEF DESCRIPTION OF THE DRAWINGS

FIG. 1 is a flowchart diagram of a training method for an analog hardware neural network according to the present disclosure.

FIG. 2 is a structural block diagram of a training device for an analog hardware neural network according to the present disclosure.

FIG. 3 is a schematic diagram of injecting a perturbation signal according to the present disclosure.

### DETAILED DESCRIPTIONS OF THE EMBODIMENTS

The technical solution of the present disclosure will be further described below with reference to the accompanying drawings and the embodiments.

### Embodiment 1

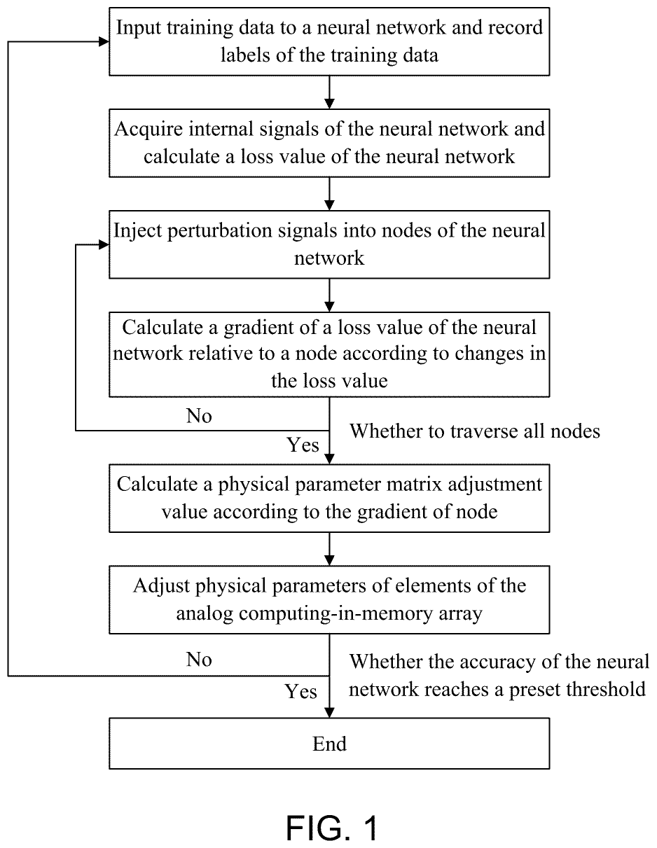

A training method for an analog hardware neural network described in the present disclosure has a process shown in FIG. 1, including:
1. converting training data into analog signals, inputting the analog signals into the analog hardware neural network, and recording labels of the training data;
2. acquiring internal signals of the analog hardware neural network after the analog hardware neural network establishes a response to the input signals, converting the internal signals into digital signals, and calculating a loss value of the neural network;
3. injecting a perturbation signal z into a node a of a nonlinear unit in the analog hardware neural network, and calculating a gradient of the loss value of the neural network relative to the node a according to changes in the loss value of the neural network before and after the perturbation signal is injected;
4. traversing nodes, calculating physical parameter matrix adjustment values of elements in an analog computing-in-memory array of each layer of the neural network according to a gradient of the loss value of the analog hardware neural network relative to each nonlinear unit layer and the acquired internal signals of the analog hardware neural network, as well as a connection relationship between each nonlinear unit layer and the elements in the analog computing-in-memory array;
5. adjusting physical parameters of the analog computing-in-memory array of each layer of the neural network according to the physical parameter matrix adjustment values of elements in an analog computing-in-memory array of each layer of the neural network to realize the training of the analog hardware neural network; and
6. repeating the training until the accuracy of the analog hardware neural network reaches a preset threshold.

Specifically, the acquiring internal signals of the analog hardware neural network, converting the internal signals into digital signals, and calculating a loss value of the analog hardware neural network includes: acquiring analog input signals of the computing-in-memory array of each layer of the neural network and analog output signals of the analog hardware neural network, converting the analog input signals and the analog output signals into digital signals, and calculating a loss value (Loss) of the neural network according to the converted analog output signals and labels of corresponding training data.

The loss value Loss is calculated according to the converted analog output signals using a mean-squared error function as follows:

$$Loss = \frac{1}{n} \sum {( y - label )}^{2}$$

in the formula, y is an analog output signal of the analog hardware neural network after being converted by an analog-to-digital converter (ADC), label is a label of the corresponding training data, and n is a number of samples of the training data. For example, for a handwritten digit recognition task, a recognition target is digits from 0 to 9, the label is encoded as follows:

$$0 \to [ 1 , 0 , 0 , 0 , 0 , 0 , 0 , 0 , 0 , 0 ] ;$$

$$1 \to [ 0 , 1 , 0 , 0 , 0 , 0 , 0 , 0 , 0 , 0 ] ;$$

$$… ;$$

$$9 \to [ 0 , 0 , 0 , 0 , 0 , 0 , 0 , 0 , 0 , 1 ] .$$

This embodiment illustrates an example only, and the loss value can also be calculated using other functions.

For the calculating a gradient of the loss value of the neural network relative to the node a according to changes in the loss value of the neural network before and after the perturbation signal is injected, a calculation formula is as follows:

$$∇ Loss {\vert}_{a} = \frac{\partial Loss}{\partial z}$$

in the formula, ∇Loss|ₐ is a gradient of the loss value of the neural network relative to the node a, an amplitude Δz of the perturbation signal z is used to replace ∂z for calculation, and changes in the loss value of each layer of the neural network before and after the perturbation signal is injected are used to replace ∂Loss for calculation.

The gradient of the loss value of the analog hardware neural network relative to each nonlinear unit layer is composed of gradients of the loss value of the neural network relative to nodes of each nonlinear unit, which can be expressed as a vector, and a calculation formula is as follows:

$$δ {\vert}_{n} = [ ∇ Loss {\vert}_{a 1} , ∇ Loss {\vert}_{a 2} , … , ∇ Loss {\vert}_{a m} ]$$

in the formula, δ is a gradient of the loss value of the neural network relative to a nonlinear unit layer, a subscript n represents an n^{th} nonlinear unit layer, subscripts a1, a2, am, and the like represents gradients of the loss value of the neural network relative to different nodes, and m is a total number of nonlinear unit nodes in an n^{th} layer.

For the traversing nodes, calculating physical parameter matrix adjustment values of elements in an analog computing-in-memory array of each layer of the neural network according to a gradient of the loss value of the analog hardware neural network relative to each nonlinear unit layer and the acquired internal signals of the analog hardware neural network, as well as a connection relationship between each nonlinear unit layer and the elements in the analog computing-in-memory array, a calculation formula is as follows:

$$Δ W = η ( {I}_{n} \times δ {\vert}_{n} ) .$$

in the formula, W represents a physical parameter matrix of elements in an analog computing-in-memory array in an n^{th} layer, η is an adjustment coefficient of the physical parameter matrix, δ|ₙ is a gradient of the loss value of the neural network relative to an n^{th} nonlinear unit layer, and Iₙ is an input signal of the analog computing-in-memory array.

The present disclosure uses a perturbation signal to calculate the gradient of each layer of the analog hardware neural network. Signals only need to propagate forward in a physical system to obtain the gradient, without involving any backpropagation process or mathematical model. Since the method of the present disclosure performs forward propagation completely based on forward propagation and is free from model bias, the neural network trained using the method of the present disclosure has a higher recognition rate and generalization capabilities than the prior art. The method of the present disclosure is applicable to training all types of analog hardware neural network, thereby solving the problem of reliance on model.

### Embodiment 2

An analog hardware neural network is generally formed by cascading n layers of neural networks. Each layer of the neural network includes an analog computing-in-memory array and a nonlinear unit. The analog computing-in-memory array can perform matrix multiplication based on analog signals, which is equivalent to weights and biases in the neural network. The nonlinear unit can perform nonlinear transformation on the analog signals, which is equivalent to a nonlinear activation function in the neural network.

The analog computing-in-memory array is directly connected to the nonlinear unit, forming a fully connected layer of the analog hardware neural network. A multi-layer analog hardware neural network is formed by a direct connection of a plurality of fully connected layers.

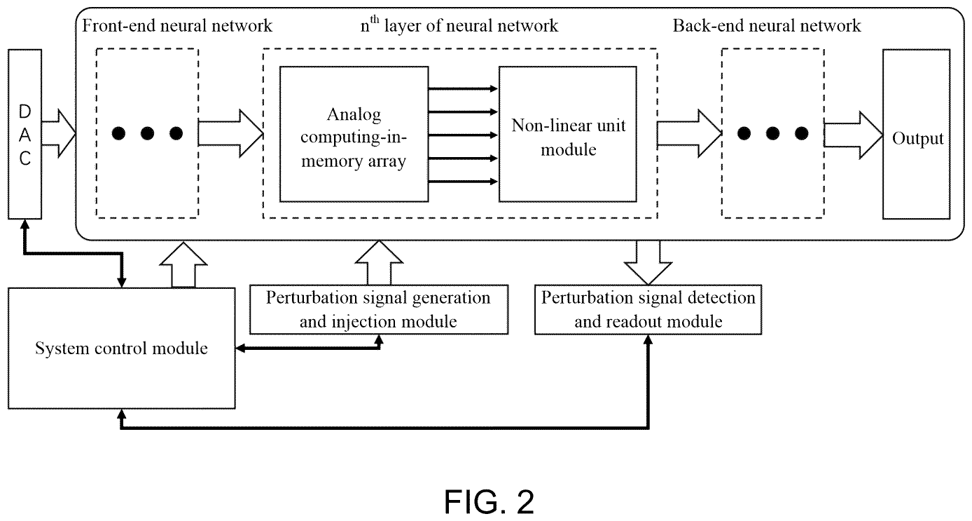

A training device for an analog hardware neural network in the present disclosure has an architecture diagram as shown in FIG. 2. The training device includes a perturbation signal generation and injection module, a system control module, a digital-to-analog conversion (DAC) module, and a perturbation signal detection and readout module.

The DAC module is configured to convert training data into analog signals, and input the analog signals into the analog hardware neural network.

The perturbation signal detection and readout module is configured to acquire internal signals of the analog hardware neural network, convert the internal signals into digital signals, and send the digital signals to the system control module.

The system control module is configured to calculate a loss value of the neural network according to the converted internal signals of the analog hardware neural network, calculate a gradient of a loss value of the neural network relative to the node a according to changes in the loss value of the neural network before and after the perturbation signal is injected; traverse nodes, and calculate physical parameter matrix adjustment values of elements in an analog computing-in-memory array of each layer of the neural network according to a gradient of the loss value of the analog hardware neural network relative to each nonlinear unit layer and the acquired internal signals of the analog hardware neural network, as well as a connection relationship between each nonlinear unit layer and the elements in the analog computing-in-memory array; and adjust physical parameters of the analog computing-in-memory array of each layer of the neural network according to the physical parameter matrix adjustment values of elements in an analog computing-in-memory array of each layer of the neural network.

The perturbation signal generation and injection module consists of a voltage source/current source, an adjustable resistor, and a multiplexer. In the above embodiment, the perturbation signal generation and injection module generates a reference bias signal using the voltage source/current source, and generates a perturbation signal with adjustable amplitude by using changes in a resistance value of the adjustable resistor. The multiplexer is configured to select a path of the perturbation signal and to select a node for injecting the perturbation signal. The perturbation signal can be injected into a node of an n^{th} layer of the neural network, where n represents any layer of the neural network.

In addition, an amplitude of the perturbation signal is generally much smaller than an amplitude of node signal of the analog hardware neural network, and usually ranges from one tenth to one ten-thousandth of the amplitude of node signal, with a specific ratio depending on training parameters of the analog hardware neural network, and the ratio can be adjusted according to the training results to obtain a best ratio.

Taking an analog hardware neural network based on an analog circuit as an example, it primarily includes an analog computing-in-memory array and a nonlinear unit module.

For an inputted set of analog signals (V), a physical parameter matrix (W) of elements in the analog computing-in-memory array satisfies a matrix multiplication relationship of I=V×W. The analog computing-in-memory array includes but is not limited to: a memristor array, where a conductance value of the memristor array correspond to a value in the physical parameter matrix of elements in the analog computing-in-memory array; a current mirror array, where switching states of a plurality of transistors in a current mirror correspond to the value in the physical parameter matrix of elements in the analog computing-in-memory array; and a floating gate transistor array, where a gate voltage of the floating gate transistors correspond to the value in the physical parameter matrix of elements in the analog computing-in-memory array.

The nonlinear unit module corresponds to a nonlinear layer in the analog hardware neural network, and is configured to perform nonlinear calculation. Output and input of the nonlinear unit module satisfy a preset nonlinear relationship.

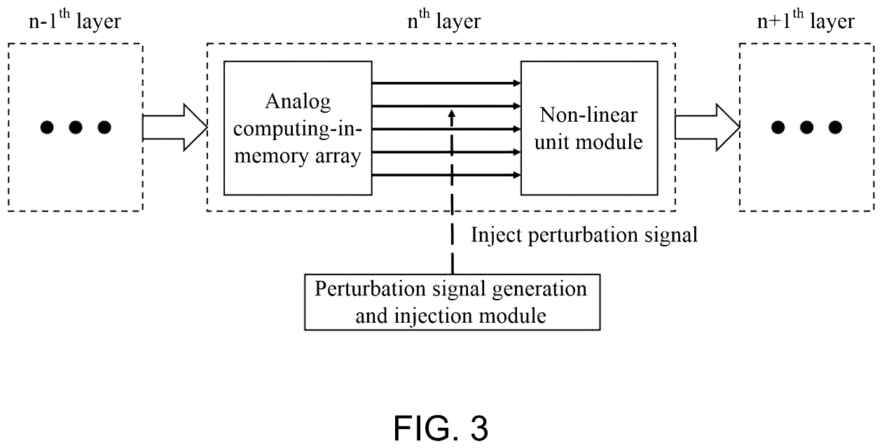

Workflow for a weight training devices of the neural network is as follows:
step 1. initializing a physical parameter matrix (W) of elements in the analog computing-in-memory array, and initializing the matrix (W) to a random value;
step 2. extracting a portion of data from a dataset and storing the portion of data in a temporary cache;
step 3. selecting a set of training data from the temporary cache, using a digital-to-analog converter (DAC) to convert the training data into analog signals, and inputting the analog signals as training signals into the analog hardware neural network; and acquiring analog input signals from the analog computing-in-memory array of each layer of the analog hardware neural network after the neural network reaches a stable output state, using the perturbation signal detection and readout module to convert the analog input signals from the analog computing-in-memory array of each layer of the analog hardware neural network into digital input signals (x), and to convert the analog output signals of the analog hardware neural network into digital output signals (y), and calculating a loss value (Loss) according to the digital output signals (y);
step 4: selecting a node (a) from input nodes of a nonlinear unit of the analog hardware neural network, and injecting a perturbation signal with an amplitude Δz into the node a using the perturbation signal generation and injection module, with a schematic diagram of injection as shown in FIG. 3;
step 5. measuring an amplitude of outputted signal using the perturbation signal detection and readout module at an output end of the neural network after the perturbation signal is continuously injected and the neural network reaches the stable output state, and using the amplitude of outputted signal to calculate and obtain Loss′;
step 6. calculating a gradient ∂L/∂z of Loss relative to the node a according to the Loss′, Loss and Δz using a finite difference method;
step 7. traversing all nodes in each layer of the analog hardware neural network to obtain a gradient of the loss value (Loss) relative to all nodes;
step 8. after obtaining gradients of the loss value (Loss) relative to all nodes of the neural network, calculating and obtaining a physical parameter matrix adjustment value (ΔW) of elements in an analog computing-in-memory array of each layer of the neural network according to input signal (a) of each layer, weight of each layer, and connection relationship between the nonlinear unit layer and the analog computing-in-memory array;
step 9. performing the above operations on all the portion of data extracted in the step 2 to obtain a plurality of sets of physical parameter matrix adjustment values ΔW of elements in the analog computing-in-memory array, and taking an average of all the weight values to be updated to obtain a final weight to be updated;
step 10. modifying a storage state of the analog computing-in-memory array to update the weight values stored therein, and a specific modification method depends on the following types of analog computing-in-memory array:
for a memristor array, using a pulse signal to modulate conductance values of memristors;
for a current mirror array, using a pulse signal to update values in a switch register, thereby changing switch states of transistors in a current mirror; and
for a floating gate transistor array, adjusting gate voltages applied to transistors; and
step 11. returning to the step 2, and extracting new data from the dataset for training until the dataset is empty, marking the completion of a round of training.

The training is repeated until the accuracy of the analog hardware neural network reaches a preset threshold.

What is claimed is:

1. A training method for an analog hardware neural network, comprising the following steps: converting training data into analog signals, inputting the analog signals into the analog hardware neural network, and recording labels of the training data; acquiring internal signals of the analog hardware neural network after the analog hardware neural network establishes a response to input signals, converting the internal signals into digital signals, and calculating a loss value of the analog hardware neural network; injecting a perturbation signal z into a node a of nonlinear units in the analog hardware neural network, and calculating a gradient of the loss value of the analog hardware neural network relative to the node a according to changes in the loss value of the analog hardware neural network before and after the perturbation signal is injected; traversing nodes, calculating physical parameter matrix adjustment values of elements in an analog computing-in-memory array of each of layers of the analog hardware neural network according to a gradient of the loss value of the analog hardware neural network relative to each of nonlinear unit layers and the internal signals, which are acquired, of the analog hardware neural network, as well as a connection relationship between each of the nonlinear unit layers and the elements in the analog computing-in-memory array; and adjusting physical parameters of the analog computing-in-memory array of each of layers of the analog hardware neural network according to the physical parameter matrix adjustment values of the elements in an analog computing-in-memory array of each of layers of the analog hardware neural network to realize the training of the analog hardware neural network;
calculating the gradient of the loss value of the analog hardware neural network relative to the node a according to the changes in the loss value of the analog hardware neural network before and after the perturbation signal is injected is performed as follows:
$$∇ Loss {\vert}_{a} = \frac{\partial Loss}{\partial z}$$
wherein ∇Loss|ₐ is the gradient of the loss value of the analog hardware neural network relative to the node a, an amplitude Δz of the perturbation signal z is used to replace ∂z for calculation, and the changes in the loss value of the analog hardware neural network before and after the perturbation signal is injected are used to replace ∂Loss for calculation;
the gradient of the loss value of the analog hardware neural network relative to each of the nonlinear unit layers is composed of gradients of the loss value of the analog hardware neural network relative to nodes of each of the nonlinear units, which is expressed as a vector and calculated as follows:
$$δ {\vert}_{n} = [ ∇ Loss {\vert}_{a 1} , ∇ Loss {\vert}_{a 2} , … , ∇ Loss {\vert}_{a m} ]$$
wherein δ is a gradient of the loss value of the analog hardware neural network relative to a nonlinear unit layer, a subscript n represents an n^{th} nonlinear unit layer, ∇Loss|ₐ₁˜∇Loss|ₐₘ represents gradients of the loss value of the analog hardware neural network relative to different nodes, and m is a total number of nonlinear unit nodes in an n^{th} layer.

2. The training method for the analog hardware neural network according to claim 1, wherein the amplitude of the perturbation signal is smaller than 10% of an amplitude of the internal signals of the analog hardware neural network; and the amplitude of the perturbation signal is 0.1%-1% of the amplitude of the internal signals.

3. The training method for the analog hardware neural network according to claim 1, wherein calculating the gradient of the loss value of the analog hardware neural network relative to the node a according to the changes in the loss value of the analog hardware neural network before and after the perturbation signal is injected comprises: detecting and acquiring the internal signals of the analog hardware neural network and calculating changes of the loss value after the perturbation signal is injected into the node a to obtain the gradient of the loss value of the analog hardware neural network relative to the node a.

4. The training method for the analog hardware neural network according to claim 1, wherein the internal signals of the analog hardware neural network comprise: analog input signals of the computing-in-memory array of each layer of the analog hardware neural network and analog output signals of the analog hardware neural network.

5. The training method for the analog hardware neural network according to claim 1, wherein the calculating a loss value of the analog hardware neural network comprises calculating a loss value Loss of the analog hardware neural network according to the digital signals, which are converted, and labels of corresponding training data of the analog hardware neural network.

6. The training method for the analog hardware neural network according to claim 5, wherein the calculating a loss value Loss of the analog hardware neural network according to the digital signals, which are converted, and labels of corresponding training data of the analog hardware neural network adopts a mean-squared error function as follows:
$$Loss = \frac{1}{n} \sum {( y - label )}^{2}$$
wherein y is an analog output signal of the analog hardware neural network after being converted by an analog-to-digital converter (ADC), label is a label of the corresponding training data, and n is a number of samples of the training data.

7. The training method for the analog hardware neural network according to claim 1, wherein the calculating physical parameter matrix adjustment values of the elements in an analog computing-in-memory array of each layer of the analog hardware neural network according to the gradient of the loss value of the analog hardware neural network relative to each of the nonlinear unit layers and the internal signals, which are acquired, of the analog hardware neural network, as well as a connection relationship between each of the nonlinear unit layers and the elements in the analog computing-in-memory array are performed as follows:
$$Δ W = η ( {I}_{n} \times δ {\vert}_{n} ) ,$$
wherein W represents a physical parameter matrix of elements in an analog computing-in-memory array in an n^{th} layer, η is an adjustment coefficient of the physical parameter matrix, δ|ₙ is a gradient of the loss value of the analog hardware neural network relative to an n^{th} nonlinear unit layer, and Iₙ is a converted input signal of the analog computing-in-memory array.

8. A training device for an analog hardware neural network, comprising:
a digital-to-analog conversion module configured to convert training data into analog signals, and input the analog signals into the analog hardware neural network;
a perturbation signal generation and injection module configured to inject a perturbation signal into a node of nonlinear units in the analog hardware neural network;
a perturbation signal detection and readout module configured to acquire internal signals of the analog hardware neural network, convert the internal signals into digital signals, and send the digital signals to a system control module; and
the system control module configured to calculate a loss value of the analog hardware neural network according to the internal signals, which are converted, of the analog hardware neural network, calculate a gradient of the loss value of the analog hardware neural network relative to a node a according to changes in the loss value of the analog hardware neural network before and after the perturbation signal is injected; control the perturbation signal to traverse nodes, and calculate physical parameter matrix adjustment values of elements in an analog computing-in-memory array of each layer of the analog hardware neural network according to a gradient of the loss value of the analog hardware neural network relative to each of nonlinear unit layers and the internal signals, which are acquired, of the analog hardware neural network, as well as a connection relationship between each of the nonlinear unit layers and the elements in the analog computing-in-memory array; and adjust physical parameters of the analog computing-in-memory array of each layer of the analog hardware neural network according to the physical parameter matrix adjustment values of the elements in an analog computing-in-memory array of each layer of the analog hardware neural network; wherein
calculating the gradient of the loss value of the analog hardware neural network relative to the node a according to the changes in the loss value of the analog hardware neural network before and after the perturbation signal is injected is performed as follows:
$$∇ Loss {\vert}_{a} = \frac{\partial Loss}{\partial z}$$
wherein ∇Loss|ₐ is the gradient of the loss value of the analog hardware neural network relative to the node a, an amplitude Δz of the perturbation signal z is used to replace ∂z for calculation, and the changes in the loss value of the analog hardware neural network before and after the perturbation signal is injected are used to replace ∂Loss for calculation;
the gradient of the loss value of the analog hardware neural network relative to each of the nonlinear unit layers is composed of gradients of the loss value of the analog hardware neural network relative to nodes of each of the nonlinear units, which is expressed as a vector and calculated as follows:
$$δ {\vert}_{n} = [ ∇ Loss {\vert}_{a 1} , ∇ Loss {\vert}_{a 2} , … , ∇ Loss {\vert}_{a m} ]$$
wherein δ is a gradient of the loss value of the analog hardware neural network relative to a nonlinear unit layer, a subscript n represents an n^{th} nonlinear unit layer, ∇Loss|ₐ₁˜∇Loss|ₐₘ represents gradients of the loss value of the analog hardware neural network relative to different nodes, and m is a total number of nonlinear unit nodes in an n^{th} layer.

9. The training device for the analog hardware neural network according to claim 8, wherein the acquiring internal signals of the analog hardware neural network comprises: acquiring analog input signals of the computing-in-memory array of each layer of the analog hardware neural network and analog output signals of the analog hardware neural network.

10. The training device for the analog hardware neural network according to claim 8, wherein the analog computing-in-memory array comprises a memristor array, a current mirror array, and a floating gate transistor array; wherein for the memristor array, the adjust physical parameters of the analog computing-in-memory array of each layer of the analog hardware neural network involves using a pulse signal to modulate conductance values of memristors; for the current mirror array, the adjust physical parameters of the analog computing-in-memory array of each layer of the analog hardware neural network involves using a pulse signal to update values in a switch register, so as to change switch states of transistors in a current mirror; and for the floating gate transistor array, the adjust physical parameters of the analog computing-in-memory array of each layer of the analog hardware neural network involves adjusting gate voltages applied to transistors.

11. The training device for the analog hardware neural network according to claim 8, wherein amplitude and frequency of the perturbation signal generated by the perturbation signal generation and injection module are adjustable.

12. The training device for the analog hardware neural network according to claim 8, wherein the perturbation signal generation and injection module comprises a voltage source/current source, an adjustable resistor, and a multiplexer; wherein the voltage source/current source generates a reference bias signal, and generates a perturbation signal with adjustable amplitude by using changes in a resistance value of the adjustable resistor; and the multiplexer is configured to connect nodes and inject the perturbation signal into the nodes.
